(19) United States
(12) Patent Application Publication
(10) Pub. No.: US 2014/0160300 A1
(43) Pub. Date: Jun. 12, 2014

(54) NETWORK CAMERA

(71) Applicant: Sercomm Corporation, Tapei (TW)

(72) Inventor: Sung-Chun Hung, Taipei City (TW)

(73) Assignee: Sercomm Corporation, Tapei (TW)

(21) Appl. No.: 13/959,781

(22) Filed: Aug. 6, 2013

(30) Foreign Application Priority Data
Dec. 7, 2012 (CN) 201220672622.5

(51) Int. Cl. H04N 5/33

(52) U.S. Cl. CPC H04N 5/33
USPC 348/164

(57) ABSTRACT

A network camera comprising an infrared light emitting component, a night lens, an infrared light penetrable cover and a shading ring is provided. The infrared light penetrable cover covers the night lens and the infrared light emitting component, and has a through hole from which the night lens is exposed. The shading ring is disposed on the infrared light penetrable cover and surrounding the night lens to shade and prevent the light emitted by the infrared light emitting component from being outputted off the through hole. The network camera of the invention can adopt a short type infrared light emitting component to simplify the assembly of the network camera.

This application claims the benefit of People's Republic of China application Serial No. 201220672622.5, filed on Dec. 7, 2012, the subject matter of which is incorporated herein by reference.

### BACKGROUND OF THE INVENTION

1. Field of the Invention

The invention relates in general to a network camera, and more particularly to a network camera having an infrared light penetrable cover.

2. Description of the Related Art

The casing of conventional network camera, such as an IP cam, is not penetrable to the light. For the light emitted by the light emitting diodes (LEDs) disposed in the network camera to be able to be outputted off the casing, a through hole, from which the LEDs are exposed, must be formed on the casing. This may allow the light to be outputted off the casing to provide necessary illumination when the night lens captures an image. The above method must use long type LEDs which are exposed from the through hole. However, the long type LEDs are disposed manually, and the manual disposition of the long type LEDs is very time consuming and labor consuming.

### SUMMARY OF THE INVENTION

The invention is directed to a network camera having a short type infrared light emitting component for benefiting the assembly of the network camera.

According to one embodiment of the present invention, a network camera is provided. The network camera comprises an infrared light emitting component, a night lens, an infrared light penetrable cover, and a first light shading ring. The infrared light penetrable cover covers the night lens and the infrared light emitting component, and has a first through hole from which the night lens is exposed. The first light shading ring is disposed on the infrared light penetrable cover and surrounding the night lens to shade and prevent the infrared light emitted by the infrared light emitting component from being outputted off the first through hole.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a top view of an network camera according to an embodiment of the invention;

FIG. 2 shows a cross-sectional view along a direction 2-2′ of FIG. 1;

FIG. 3 shows an appearance diagram of the inner side of the infrared light penetrable cover of FIG. 2;

FIG. 4 shows a cross-sectional view along a direction 3-3′ direction of FIG. 1;

FIG. 5 shows a partial cross-sectional view of a network camera according to another embodiment of the invention; and

FIG. 6 shows a partial cross-sectional view of a network camera according to another embodiment of the invention.

### DETAILED DESCRIPTION OF THE INVENTION

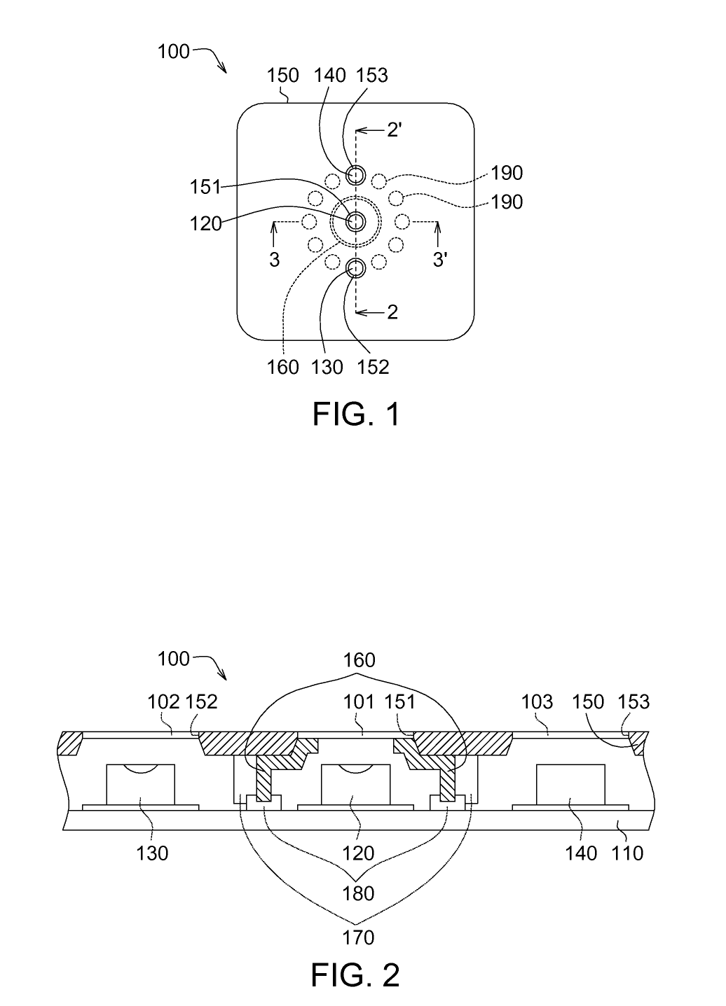

Referring to FIG. 1 and FIG. 2. FIG. 1 shows a top view of a network camera according to an embodiment of the invention. FIG. 2 shows a cross-sectional view along a direction 2-2′ of FIG. 1. The network camera 100 comprises a circuit board 110, a night lens 120, a day lens 130, a light sensor 140, an infrared light penetrable cover 150, a first light shading ring 160, a second light shading ring 170, a third light shading ring 180 and at least one infrared light emitting component 190.

The night lens 120, the day lens 130 and the light sensor 140 are disposed on the circuit board 110. The night lens 120 is used to capture images in the night time, and the day lens 130 is used to capture images in the day time. The light sensor 140 can detect the intensity of the light. A controller (not illustrated) is disposed on the circuit board 110 to control the ON/OFF state of the night lens 120 and the day lens 130 according to the detected intensity of the light.

The infrared light penetrable cover 150 covers the night lens 120, the day lens 130, the light sensor 140 and the infrared light emitting components 190. The infrared light penetrable cover 150 has a first through hole 151, a second through hole 152 and a third through hole 153 from which the night lens 120, the day lens 130 and the light sensor 140 are exposed, respectively. The network camera 100 further comprises a first light penetrable cover 101, a second light penetrable cover 102 and a third light penetrable cover 103 disposed at the opening of the first through hole 151, the opening of the second through hole 152 and the opening of the third through hole 153, respectively. The first light penetrable cover 101, the second light penetrable cover 102 and the third light penetrable cover 103 protect the night lens 120, the day lens 130 and the light sensor 140 and prevent external substances from entering the infrared light penetrable cover 150 via these openings.

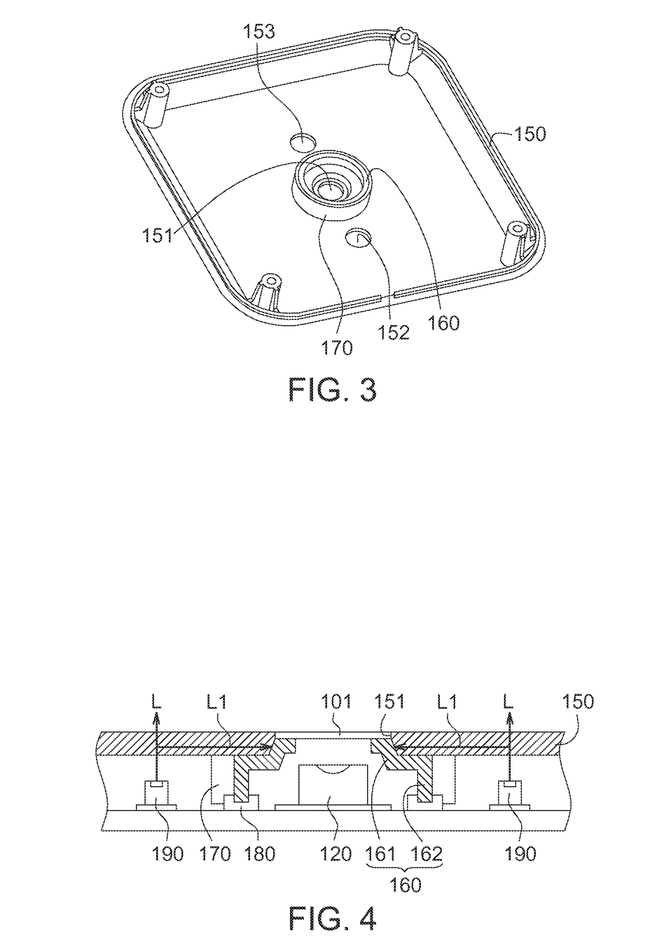

Referring to FIG. 3, an appearance diagram of the inner side of the infrared light penetrable cover of FIG. 2 is shown. The first light shading ring 160 is disposed on the infrared light penetrable cover 150. The first light shading ring 160 and the infrared light penetrable cover 150 can be integrally formed in one piece by using the buried mold injection molding method or the secondary injection molding method. Alternatively, after the first light shading ring 160 and the infrared light penetrable cover 150 are formed respectively, the first light shading ring 160 and the infrared light penetrable cover 150 are combined together by way of coupling, adhering, locking or any other temporary or permanent methods. The first light shading ring 160 can be formed by plastics, rubber, foam or a combination thereof.

The second light shading ring 170 is mounted on the outer lateral side of the first light shading ring 160 to increase or satisfy the effect of shading the infrared ray. In another example, the second light shading ring 170 can be omitted if the first light shading ring 160 is thick enough to provide expected effect of shading the infrared ray.

Referring to FIG. 4, a cross-sectional view along a direction 3-3′ direction of FIG. 1 is shown. In the present example, the second light shading ring 170 is not extended to the circuit board 110. In another example, the second light shading ring 170 can be extended to the circuit board 110.

When the infrared light penetrable cover 150 covers the night lens 120 and the first light shading ring 160 surrounds the night lens 120, the infrared light penetrable cover 150 shades and prevent the infrared light emitted by the infrared light emitting components 190 from being outputted towards the first through hole 151. As a result, the infrared light will not or will less affect the image capturing quality of the night lens 120. In the present example, the first light shading ring 160 comprises a first sub-light shading ring 161 covering the entire side wall of the first through hole 151 to shade and prevent the stray light L1 emitted by the infrared light emitting components 190 from being outputted off the first through hole 151 via the infrared light penetrable cover 150. As a result, the stray light L1 will not or will less affect the image capturing quality of the night lens 120.

The first light shading ring 160 further comprises a second sub-light shading ring 162. The second sub-light shading ring 162 is connected to the first sub-light shading ring 161 and extended from the infrared light penetrable cover 150 towards the circuit board 110.

The third light shading ring 180 is disposed on the circuit board 110 and located between the first light shading ring 160 and the circuit board 110. The first light shading ring 160 is extended to the third light shading ring 180 to completely isolate the night lens 120 and the infrared light emitting components 190 to prevent the infrared light L from entering the first light shading ring 160 and then being outputted off the first through hole 151. Besides, the second light shading ring 170 leans on a portion of the third light shading ring 180 (that is, a portion of the second light shading ring 170 is indented into the third light shading ring 180) to prevent the infrared light L from entering the first light shading ring 160 via the connection between the second sub-light shading ring 162 and the third light shading ring 180 and then being outputted off the first through hole 151.

The third light shading ring 180 and the first light shading ring 160 both relate to a closed light shading ring. The third light shading ring 180 and the first light shading ring 160 surround and enclose the night lens 120 to prevent the infrared light L from entering the first light shading ring 160 and then being outputted off the first through hole 151. The third light shading ring 180 is formed by plastics, rubber, foam or a combination thereof. The second light shading ring 170 and the third light shading ring 180 can be formed by the same or different materials.

A plurality of infrared light emitting components 190 are disposed on the circuit board 110 and surrounding the night lens 120 and the first light shading ring 160. The infrared light emitting components 190, disposed opposite to the infrared light penetrable cover 150, emits an infrared light L towards the infrared light penetrable cover 150. Since the infrared light penetrable cover 150 is formed by a material penetrable to the infrared ray, the infrared light L emitted by the infrared light emitting components 190 can penetrate the infrared light penetrable cover 150 and provide necessary illumination when the night lens 120 captures an image. Since the infrared light emitting components 190 do not have to be projected above the infrared light penetrable cover 150, both the surface adhering type and the short type infrared light emitting components can be used to simplify the assembly of the infrared light emitting components.

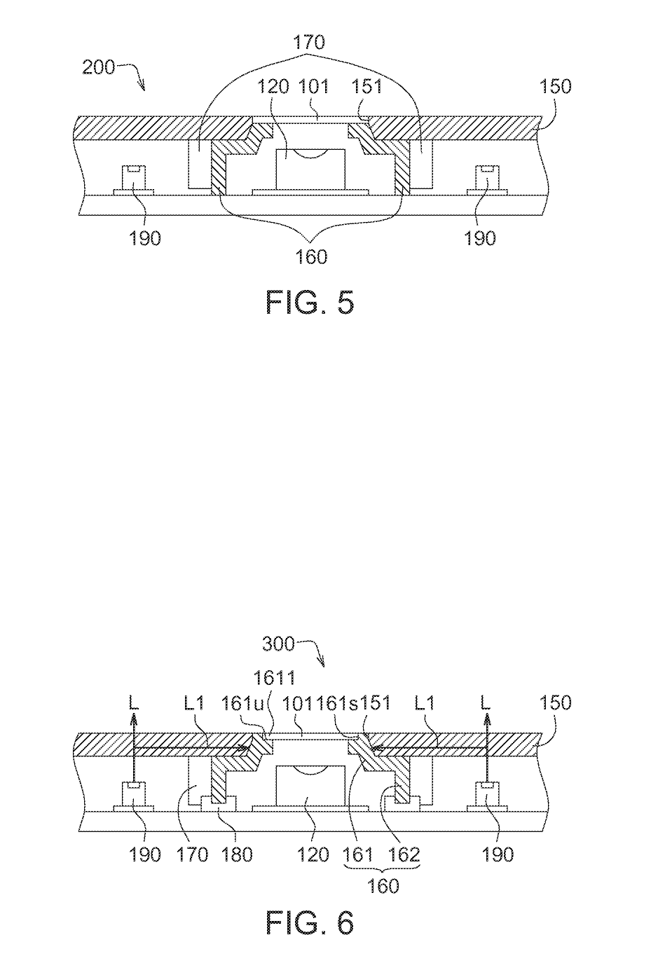

Referring to FIG. 5, a partial cross-sectional view of a network camera according to another embodiment is shown. The network camera 200 comprises a circuit board 110, a night lens 120, a day lens 130 (not illustrated), a light sensor 140 (not illustrated), an infrared light penetrable cover 150, a first light shading ring 160, a second light shading ring 170, a third light shading ring 180 and at least one infrared light emitting components 190 (not illustrated). In the present example, the network camera 200 does not have the third light shading ring 180. Under such design, the first light shading ring 160 can be extended to the circuit board 110 to isolate the infrared light emitting components 190 and the night lens 120. In another example, it is not the first light shading ring 160 but the second light shading ring 170 that is extended to the circuit board 110 to isolate the infrared light emitting components 190 and the night lens 120. In an example, the first light shading ring 160 and the second light shading ring 170 are both extended to the circuit board 110.

Referring to FIG. 6, a partial cross-sectional view of a network camera according to another embodiment of the invention is shown. The network camera 200 comprises a circuit board 110, a night lens 120, a day lens 130 (not illustrated), a light sensor 140 (not illustrated), an infrared light penetrable cover 150, a first light shading ring 160, a second light shading ring 170, a third light shading ring 180 and at least one infrared light emitting components 190 (not illustrated). In the present example, the first light penetrable cover 101 is disposed in the carrying recess 1611 of the first sub-light shading ring 161, wherein the carrying recess 1611 has an inner side wall 161s and an upper carrying surface 161u. The first sub-light shading ring 161 is engaged on the inner side wall 161s and located on the upper carrying surface 161u. The first sub-light shading ring 161 of the first light shading ring 160, covering the entire side wall of the first through hole 151, can completely shade and prevent the stray light L1 emitted by the infrared light emitting components 190 from being outputted off the first through hole 151 via the infrared light penetrable cover 150. As a result, the stray light L1 will not or will less affect the image capturing quality of the night lens 120.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A network camera comprising:
an infrared light emitting component;
a night lens;
an infrared light penetrable cover covering the night lens and the infrared light emitting component and having a first through hole from which the night lens is exposed; and
a first light shading ring disposed on the infrared light penetrable cover and surrounding the night lens to shade and prevent infrared light emitted by the infrared light emitting component from being outputted off the first through hole.

2. The network camera according to claim 1, wherein the first light shading ring comprises:
a first sub-light shading ring covering a side wall of the first through hole to shade and prevent stray light emitted by the infrared light emitting component from being outputted off the first through hole via the infrared light penetrable cover.

3. The network camera according to claim 2, wherein the first sub-light shading ring covers the entire side wall of the first through hole.

4. The network camera according to claim 1, further comprising:
a circuit board on which the infrared light emitting component and the night lens are disposed;
wherein the first light shading ring comprises a second sub-light shading ring extended from the infrared light penetrable cover towards the circuit board.

5. The network camera according to claim 4, wherein the second sub-light shading ring is extended to the circuit board.

6. The network camera according to claim 1, further comprising:
a second light shading ring mounted on an outer lateral side of the first light shading ring.

7. The network camera according to claim 6, wherein the second light shading ring is formed by plastics, rubber, foam or a combination thereof.

8. The network camera according to claim 6, wherein the second light shading ring is a closed light shading ring.

9. The network camera according to claim 6, further comprising:
a circuit board; and
a third light shading ring disposed between the first light shading ring and the circuit board;
wherein the first light shading ring leans on the third light shading ring, and the second light shading ring covers an outer lateral side of the third light shading ring.

10. The network camera according to claim 1, further comprising:
a circuit board; and
a third light shading ring disposed between the first light shading ring and the circuit board;
wherein the first light shading ring leans on the third light shading ring.

11. The network camera according to claim 10, wherein the third light shading ring is formed by plastics, rubber, foam or a combination thereof.

12. The network camera according to claim 10, wherein the third light shading ring is a closed light shading ring.

13. The network camera according to claim 1, further comprising:
a plurality of infrared light emitting components surrounding the first light shading ring.

14. The network camera according to claim 1, wherein the first light shading ring is a closed light shading ring.

15. The network camera according to claim 1, wherein the first light shading ring and the infrared light penetrable cover are integrally formed in one piece.

16. The network camera according to claim 1, wherein the first light shading ring is formed by plastics, rubber, foam or a combination thereof.

17. The network camera according to claim 1, further comprising:
a day lens;
wherein the infrared light penetrable cover has a second through hole from which the day lens is exposed.

18. The network camera according to claim 1, further comprising:
a light sensor;
wherein the infrared light penetrable cover has a third through hole from which the light sensor is exposed.
